(19) United States
(12) Patent Application Publication
(10) Pub. No.: US 2007/0039439 A1
(43) Pub. Date: Feb. 22, 2007

(54) Router-Mate

(75) Inventor: Joseph A. Tocci, Fort Wayne, IN (US)

Correspondence Address: Mr. Joseph A. Tocci, 5525A Coldwater Rd., Box 107, Fort Wayne, IN, 46825, US

(73) Assignee: Joseph A. Tocci, Fort Wayne, IN (US)

(21) Appl. No.: 11/161,780

(22) Filed: Aug. 16, 2005

(51) Int. Cl. B26D 7/06

(52) U.S. Cl. 83/78

(57) ABSTRACT

A device that integrates a router table to a collapsing table saw. The device mounts the router in an inverted position and does not interfere with any function of the standard RIDGID TS2400 table saw. The device can be left attached to the table saw with or without the router in place, both in the working and collapsed configurations of the portable table saw. The device is locked into place on the table saw by means of retractable latches that, in the default, released position, retain the device and maintain precise registration to the table saw's work surface.

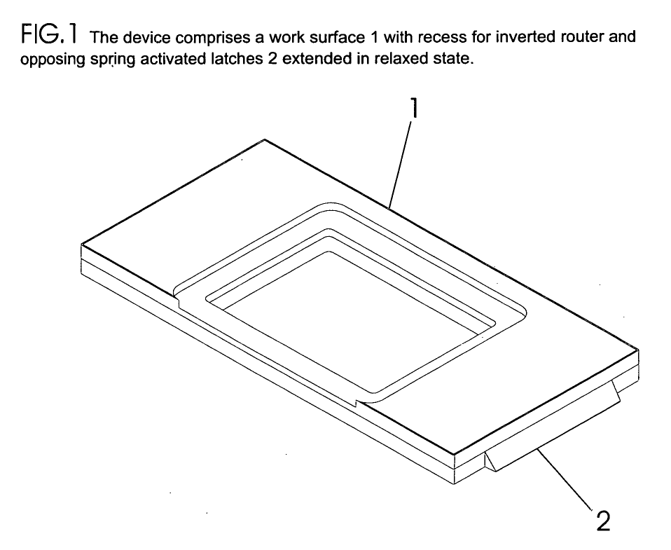

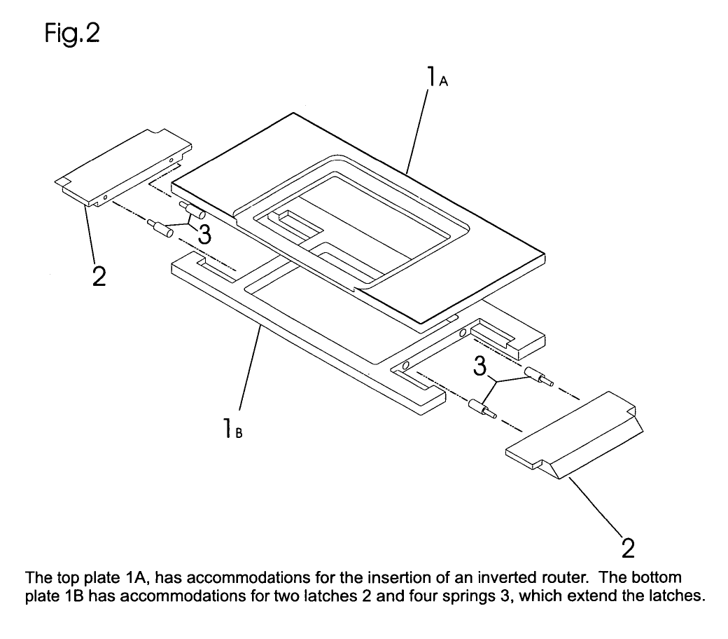

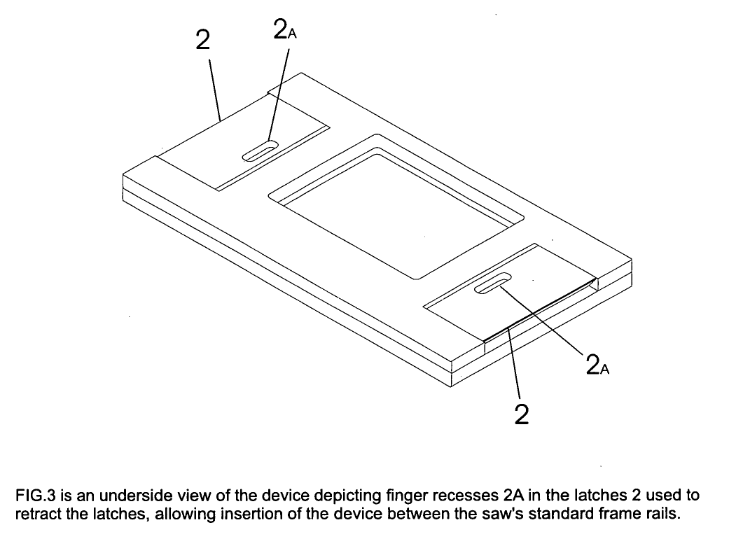

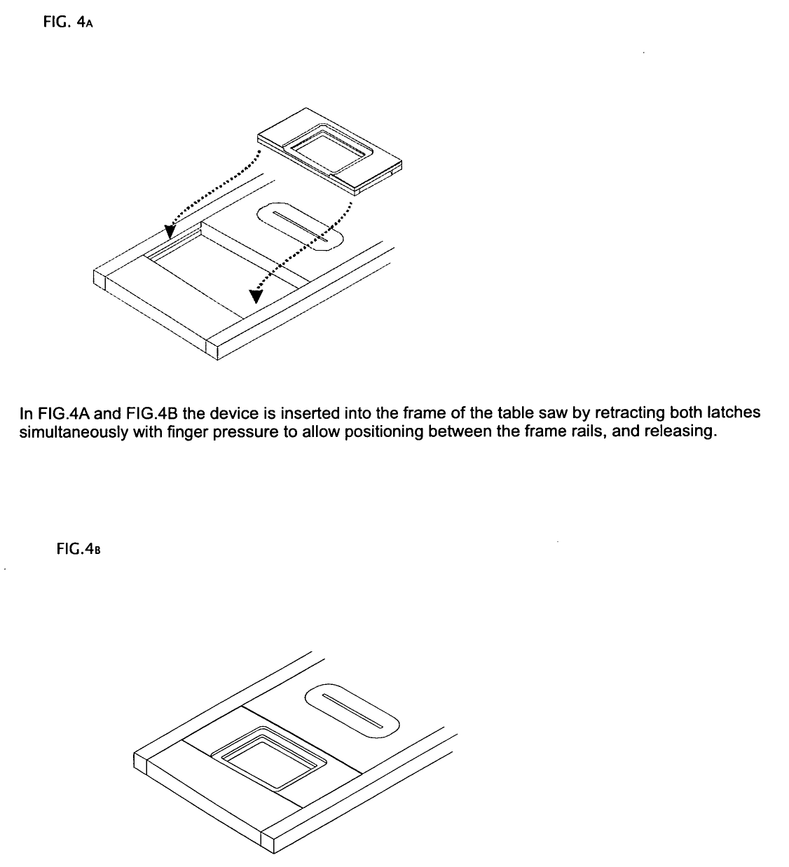

Router-Mate allows the RIDGID TS2400 portable contractor's saw, and similar table saws, to be combined with a router table into a single woodworking station.

A separate table for the router is eliminated.

What is claimed is:

1. A device that adds router table functionality to a table saw possessing an extendable table on sliding rails.

2. This device can be quickly installed and removed without the use of any tools.

3. This device automatically self-registers to the saw table surface.

4. Use of the device involves no alteration to the table saw.
